(19) United States
(12) Patent Application Publication
(10) Pub. No.: US 2015/0185497 A1
(43) Pub. Date: Jul. 2, 2015

(54) Lens Carrier

(71) Applicants: Patrick C. Ho, Hilton, NY (US); Scott Leathersich, Henrietta, NY (US); Michael M. Vacanti, Alexander, NY (US)

(72) Inventors: Patrick C. Ho, Hilton, NY (US); Scott Leathersich, Henrietta, NY (US); Michael M. Vacanti, Alexander, NY (US)

(21) Appl. No.: 14/295,797

(22) Filed: Jun. 4, 2014

Related U.S. Application Data
(60) Provisional application No. 61/922,260, filed on Dec. 31, 2013.

(51) Int. Cl. G02C 1/04; G02C 5/12; G02C 5/02

(52) U.S. Cl. CPC G02C 1/04; G02C 5/02; G02C 5/12

(57) ABSTRACT

Methods and apparatus for attaching lenses to a frame includes a lens carrier having one or more eyeglass lenses installed in one or more eye wires or rims that partially or completely encircle the lens. The lenses are joined by a nose bridge. The lens carrier includes a nose bridge spacer region and optionally a clamp that reversibly engages a brow bar or frame.

### CROSS-REFERENCE TO RELATED APPLICATIONS

This application claims the benefit of Provisional Application No. 61/922,260, filed Dec. 31, 2013, and U.S. patent application Ser. No. 29/473,795, filed on Nov. 15, 2013, the entire disclosures of which are incorporated herein by reference.

### BACKGROUND

The present invention relates generally to lens carriers, and more particularly to lens carriers for detachably securing lenses to a frame.

### SUMMARY

It is an object of the invention to provide a lens carrier that is firmly detachably secured to a frame, thereby giving the wearer the ability to attach one of a variety of different lens carriers to the frame.

It is another object of the invention to provide a method of firmly attaching the lens carrier to the frame (also called a “brow bar”) to prevent unintended or unwanted movement or shifting of the attached lenses relative to the brow bar. At the same time, the method of attachment is reversible in order to provide the user with the ability to change the brow bar or change the lens carrier.

The present disclosure is directed to inventive methods and apparatuses for detachably attaching lenses to a frame. For example, a lens carrier in accordance with the present invention provides an affordable solution for firmly attaching prescription eyeglass lenses to a brow bar or eyeglass frame. In one particular embodiment, the lens carrier includes one or more eyeglass lenses, which may be prescription, tinted, or another type of lens, installed in one or more eye wires or rims that partially or completely encircle the lenses. The lenses are joined together by a nose bridge. The nose bridge can be formed of a single member or several members, preferably having a top bar and a bottom bar. The lens carrier includes a spacer region that is situated within the nose bridge. The spacer region includes a spacer that can be formed as part of the spacer region or as a separate piece or pieces of the spacer region. The lens carrier can also include a clamp that reversibly engages a brow bar or frame between the clamp and the nose bridge or top bar. To firmly and reversibly engage the brow bar, the clamp biases the brow bar against the nose bridge. In one particular embodiment, the brow bar includes two separate nose pad arms attached to the brow bar that each extend downwardly from the brow bar and terminate in a nose pad that rests on the nose and helps keep the brow bar situated above the wearer's eyes. In an embodiment, the spacer of the lens carrier is designed to firmly fit horizontally between the nose pad arms just adjacent the top bar of the nose bridge.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective front view illustrating a lens carrier according to an embodiment attached to a brow bar;

FIG. 2 is a perspective exploded front view of a lens carrier and a brow bar according to an embodiment;

FIG. 3 is a perspective exploded front view of a lens carrier and a brow bar according to an embodiment;

FIG. 4 is a perspective back view of a lens carrier attached to a brow bar without nose pad arms according to an embodiment;

FIG. 5 is a perspective back view of a lens carrier attached to a brow bar with nose pad arms according to an embodiment;

FIG. 6 is a front view of a lens carrier attached to a brow bar according to an embodiment;

FIG. 7 is a back view of a lens carrier attached to a brow bar according to an embodiment;

FIG. 8 is a perspective exploded front view of a lens carrier and a brow bar according to an embodiment;

FIG. 9 is a perspective exploded back view of a lens carrier and a brow bar according to an embodiment;

FIG. 10 is a perspective exploded front view of a lens carrier and a brow bar according to an embodiment; and

FIG. 11 is a perspective view of a lens carrier according to an embodiment.

### DETAILED DESCRIPTION

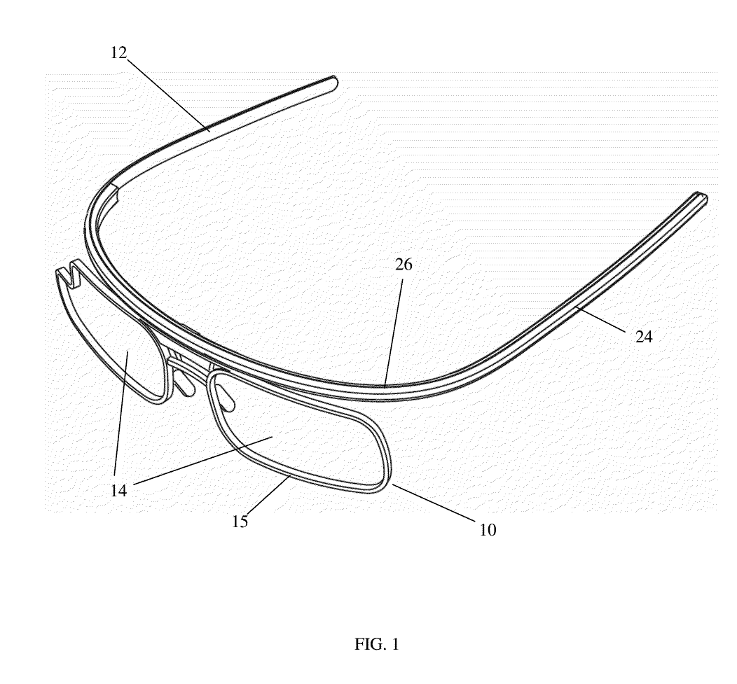

Referring now to the drawings, wherein like reference numerals refer to like parts throughout, shown in FIG. 1 is a perspective front view of a lens carrier 10 firmly attached to a brow bar 12 according to one embodiment. The lens carrier 10 includes a pair of rims 15 that house a pair of lenses 14. The brow bar 12 can be, as shown in FIG. 1, for example a metal bar 26 that extends along a user's brow and includes one or two arms 24 that sit over, on, or around the user's ears. The metal bar 26 and the two arms 24 of the brow bar 12 can be two or more different components that are permanently or reversibly affixed, or can be constructed as a single continuous piece of material. Generally, the brow bar 12 is situated above the wearer's eyes and held in place, at least in part, by the arms 24 situated behind the wearer's ears.

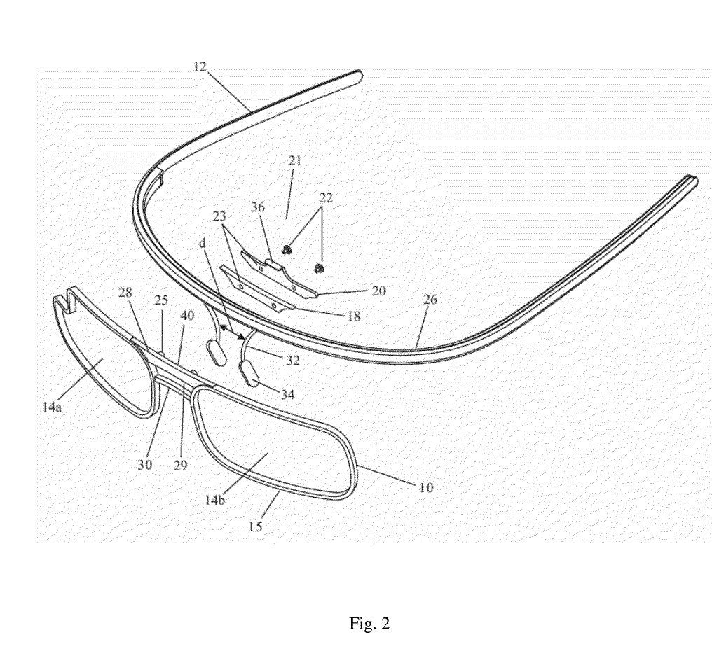

As shown in FIG. 2, the lens carrier 10 includes one or more lenses 14a and 14b. In addition to lenses designed or created specifically for this lens carrier, the lens 14 may be any lens or material that is or can be utilized in traditional eyeglasses. For example, each lens 14 may be a piece of glass, plastic, or other transparent material. The lens 14 may also be a tinted lens, such as a sunlight filtering or blocking lens. The lens 14 may also be a prescription lens, including bifocals, trifocals, and numerous other types of multifocals. The lens 14 can be treated with any known coating or strengthening method, including anti-glare and anti-scratch treatment. In some embodiments, the lens 14 can be one or more of the above.

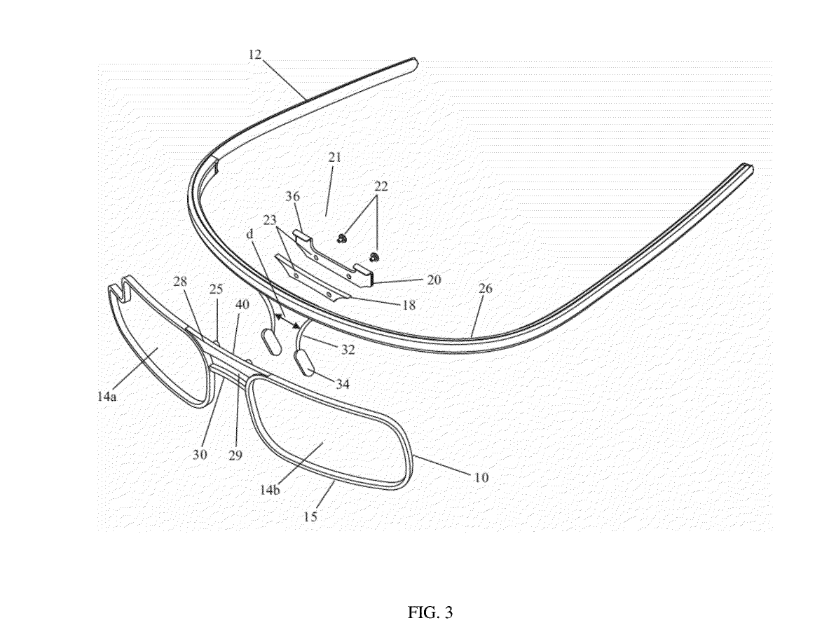

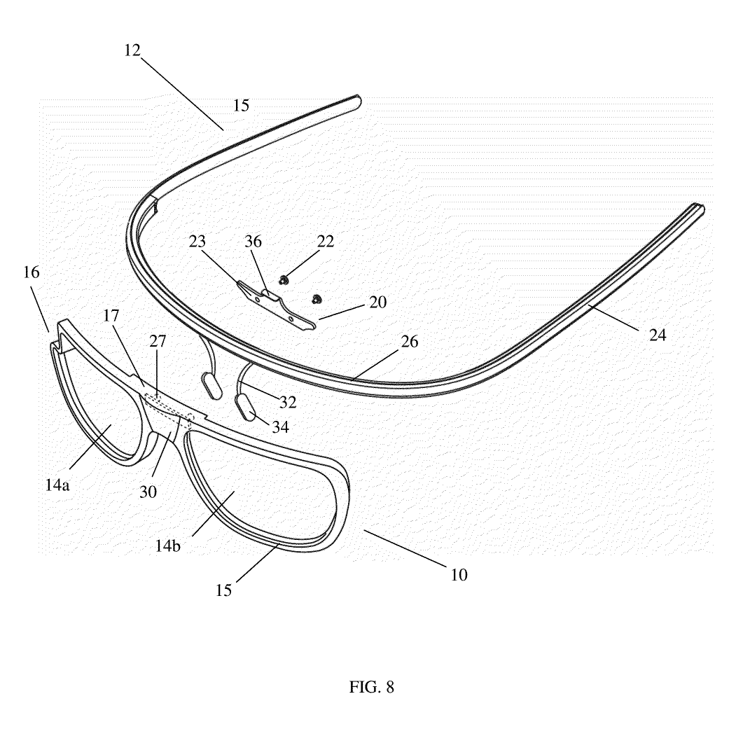

The lens 14 can be any shape that is or can be utilized in traditional eyeglasses. For example, the lens 14 can be rounded, square, oval, rectangular, or any of a variety of other shapes. Although the lens 14 is illustrated primarily as rectangular with rounded corners in the figures, it should be understood that the lenses are not in any way limited to this shape. In some embodiments, the right lens and left lens are not similarly shaped. For example, as shown more clearly in FIG. 3, the right lens 14a is shaped differently from the left lens 14b. In this embodiment, the lens 14a includes a notched portion 16 that can accommodate a structure or component, such as a structure or component (not shown) attached to a portion of the brow bar 12. Alternatively, the brow bar 12 may be structured as to extend into the notched portion 16. The notched portion 16 can be a variety of shapes and sizes. Although the figures illustrate the lens 14a with a notched portion 16, the lens 14b can be designed to be notched, as shown for example in FIG. 7. Either or both lenses can include such a notch or other accommodating structure, for example. In FIG. 11, for example, both lenses 14a and 14b include a notched portion 16.

The lenses 14 can be installed in one or more eye wires or rims 15 that partially or completely encircle the lenses 14. For example, as shown in FIG. 1, each rim 15 completely encircles each lens 14. The rim firmly holds the lens 14 in place, but can be designed to allow the lenses to be interchangeable or replaced.

According to an embodiment illustrated in FIGS. 2 and 8, the rims 15 are joined by a nose bridge 30. The nose bridge 30 can be a single structure, as shown in FIGS. 8-10 or be composed of multiple structures, such as two or more bars, as shown in FIGS. 2 and 3, for example as a top bar 28 and a bottom bar 29. Among other functions, the nose bridge 30 or the top bar 28 and bottom bar 29 add support and strength to the lens carrier 10. The nose bridge or bottom and top bars can be situated at any location along the eye rims. According to one embodiment, the nose bridge 30 or top bar 29 is as thick as the rims 15 and thus flush with the rims 15 in the front and back. According to another embodiment, the nose bridge or top bar is not as thick as the rims 15, and situated near the front, near the middle, or near the back of the thickness of the rims 15. For example, as shown in FIGS. 2 and 3, top bar 28 is situated toward the back of the thickness of rims 15. Preferably, the bridge or top bar is situated near the front, near the middle, or near the back in relation to the rim thickness to facilitate flush-mounting of the lens carrier 10 to the brow bar 12.

In one embodiment, the top bar 28 includes a back surface 40 that faces the wearer, as shown in FIGS. 2 and 3. The back surface 40 includes a spacer region that is adapted to receive and attach to a spacer 18. In an embodiment, the back surface 40 can include, for example, one or more posts 25 that extend out from the back surface 40 toward the wearer, and that can include internal threads or another mechanism to receive screws or another attachment method. Other methods and structure can be used to attach the spacer 18 to the back surface 40 of the nose bridge 30 and are included as further embodiments of the invention.

According to an embodiment illustrated in FIGS. 2 and 3, lens carrier 10 includes an attachment member 21 to attach the lens carrier to the brow bar 12. In an embodiment, the attachment member 21 is composed of the spacer 18, a clamp 20, and a clip 36, although other constructions and components are possible. The spacer 18 and clamp 20 can be constructed from a variety of different materials, including plastic, metal, polymers, and other composites. Additionally, the spacer 18 and clamp 20 can have a variety of different shapes and sizes. Although the spacer 18, clip 36 and clamp 20 are illustrated with a particular structure in the figures, it should be understood that they are not limited to these structures. According to an embodiment illustrated in FIGS. 2 and 3, spacer 18 includes one or more holes 23 that accommodate one or more screws 22. Other attachment methods are possible.

The brow bar 12 may, for example as illustrated in FIGS. 2 and 3, include one or more nose pad arms 32 that extend downwardly from the brow bar and terminate in a nose pad 34. The nose pad arms 32 may be constructed as an integral piece of the brow bar, or permanently or removably affixed to the brow bar. The nose pad arms 32 can, for example, be curved or otherwise shaped for aesthetic and/or functional purposes. Additionally, the nose pad arms 32 can be separated by a predetermined distance d that may be consistent from one brow bar to the next. In the case of nose pad arms 32 that initially curve inward toward each other and then outward away from each other, as shown in FIGS. 2 and 3, the distance d will vary along the length of the nose pad arms. The nose pads 34 can be plastic or any other suitable material. The length of the nose pad arms 32 will dictate, in part, how the brow bar 12 is situated on the wearer's face. For example, the longer the nose pad arms 32, the higher the brow bar 12 will be situated on the wearer's face.

According to an embodiment, the lens carrier 10 is configured to firmly attach to the brow bar 12. For example as shown in FIGS. 2-5, the lens carrier 10 can be affixed to the brow bar 12 by placing the spacer 18 onto the top bar 28 of the lens carrier 10 by inserting the posts 25 of the top bar into the holes 23 of the spacer 18. According to a preferred embodiment, the ends of the spacer 18 are curved or otherwise shaped to accommodate the shape of the nose pad arms 32 and the top of the spacer 18 is shaped to accommodate the shape of the brow bar 12, such as the trapezoidal-like shape shown in FIGS. 2 and 3, although other shapes are possible. The length of the spacer 18 can be configured to be about the same as or slightly less than the predetermined distance d that separates the nose pad arms 32 along the length of the nose pad arms that contact the shaped ends of the spacer 18. Accordingly, the spacer 18 will reversibly fit within the space between the two nose pad arms 32 near the brow bar 12. According to an embodiment, once the spacer 18 is placed within this space, and attached to the brow bar 12, the back of the spacer 18 can be largely flush with the back of the brow bar 12. In accordance with this embodiment, the length of the clamp 20 is configured to be slightly greater than the predetermined distance d that separates the nose pad arms 32 along the length of the nose pad arms that contact the shaped ends of the spacer 18 plus the width of the pair of nose pad arms such that the ends of the clamp 20 overhang the nose pad arms 32 which are secured between the ends of the clamp 20 and a portion of the rims 15 for a clamp-fit.

According to another embodiment, lens carrier 10 can be affixed to brow bar 12 by firmly pressing a spacer 18 affixed to the nose bridge into the space between the nose pad arms 32 such that friction between the ends of the spacer and the nose pad arms keep the spacer in place. The ends of spacer 18 are curved and notched or otherwise shaped to accommodate the shape of the nose pad arms 32 and more firmly be held in place. According to this embodiment, the length of the spacer 18 is configured to be approximately the same as or slightly greater than the predetermined distance d that separates the nose pad arms 32. Accordingly, the spacer 18 will firmly but reversibly fit within the space between the nose pad arms 32 near the brow bar 12. Once the spacer 18 is placed within this space, and attached to the brow bar 12, the back of the spacer 18 may be largely flush with the back of the brow bar 12. In accordance with this embodiment, the clamp 20 is an optional component of the attachment member 21 since the spacer is secured to the nose bridge and the nose pad arms 32 are secured between the ends of the spacer 18 and a portion of the rims 15 by a channel formed by the spacer ends and corresponding portion of the rims.

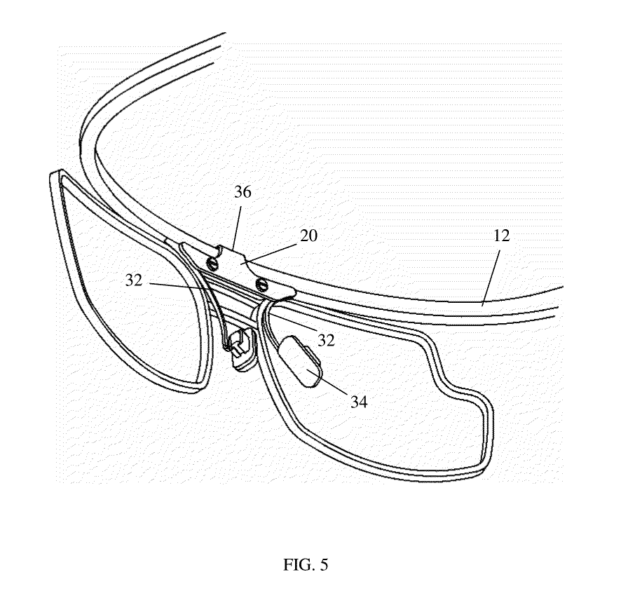

In accordance with an embodiment, once the spacer 18 is placed onto the lenses by aligning the holes 23 of the spacer 18 and the posts 25 of the top bar 28 and the nose pad arms 32 are aligned in the channels 42, and/or the spacer is firmly placed into position between the nose pad arms 32, the clamp 20 can be used to firmly affix lens carrier 10 to brow bar 12, as shown in FIG. 5. A variety of mechanisms can be utilized to affix the lens carrier 10 to the brow bar 12. For example, according to one embodiment, the clamp 20 is placed against the largely flush surface created by the properly-placed spacer 18 and the brow bar 12 is affixed in place, thereby biasing the lens carrier 10 firmly against the brow bar 12. According to an embodiment, the clamp 20 can include one or more holes 23 that align with holes 23 in the spacer 18, and thus with the posts 25. Screws 22 or another attachment mechanism can thus be utilized to firmly attach the lens carrier 10, the spacer 18, and the clamp 20 together.

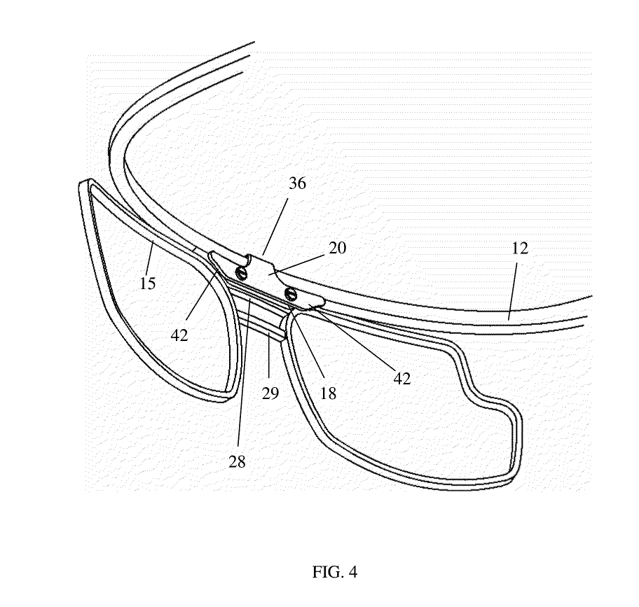

According to an embodiment, as shown in FIG. 5, for example, the length of clamp 20 is slightly greater than the thickness of both the nose pad arms 32 plus the distance d between the nose pad arms 32 so that the ends of the clamp 20 overhang the nose pad arms 32. A channel 42, as shown in FIG. 4, is formed on either side of the nose bridge at each end of the spacer 18 by a combination of the end of the spacer 18, a corresponding portion of the rim 15, and an end of the clamp 20 which overhangs the end of the spacer 18 when assembled. Each channel 42 can accommodate a nose pad arm 32. When the brow bar 12 is slightly curved along the distance of the wearer's brow, for example, the spacer 18 may also be slightly curved along its length in order to accommodate this slight curve of the brow bar 12. As a result, once the nose pad arms 32 are placed within the channels 42 and an approximately flush surface is created by the spacer 23 and the nose pad arms, the clamp 20 is placed over the spacer 18 and nose pad arms 32 and then firmly attached, thereby locking the nose pad arms 32 firmly in place.

In a preferred embodiment, the channel 42 is created on each side of the nose bridge by the combination of a portion of the following components—the spacer 18, a portion of the rim 15, and clamp 20. The channel 42 is preferably an arcuate channel which follows the shape of a portion of the nose pad arms. The channel 42 can take on any shape provided that the channel accepts a portion of the nose pad arm 32 for securing the lens carrier assembly. The channel 42 is configured to accept and affix to a portion of the nose pad arm 32. Each part contributes to the formation of the arcuate channel, which is an element of the clamping function and secures the lens carrier assembly to the frame.

The thickness of the top bar 28 may be the same or less than the thickness of joining rim 15. The position of the top bar 28 between the rims 15 may be forward or back or in between, as noted above. The spacer 18 thickness is variable and can be more or less than the thickness of the nose pad arms 32. The thickness of the spacer 18 can determine the width of the channel 42. The spacer 18 forms a first side of the three sides of the arcuate channel 42. A second side is formed by a portion of the rim 15 and the third side is formed by an overhanging end of the clamp 20. The spacer 18 serves to center the lens carrier 10 assembly on the brow bar 12. The spacer 18 provides stabilization so the lens carrier 10 does not shift or rotate in relation to the brow bar 12.

An end portion of the clamp 20 forms a third side of the three sides of the arcuate channel. In an embodiment, the clamp 20 applies a clamping force to the nose pad arm 32 when secured to the lens carrier 10, for example by the screws 22. Since the arcuate channel 42 follows the tilt of the pair of nose pad arms 32, the clamping action provides the pantoscopic tilt to the lens carrier 10.

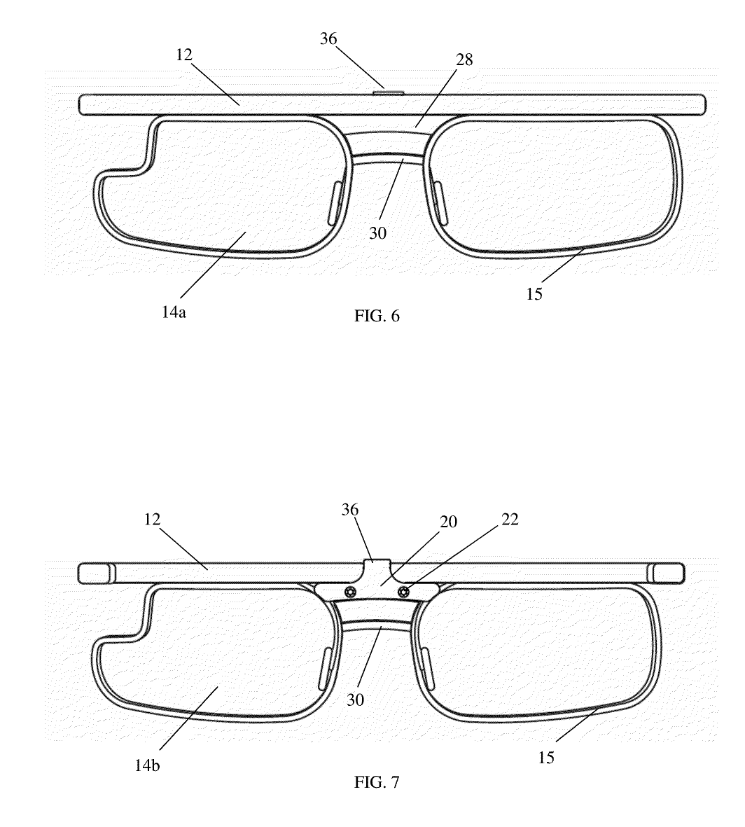

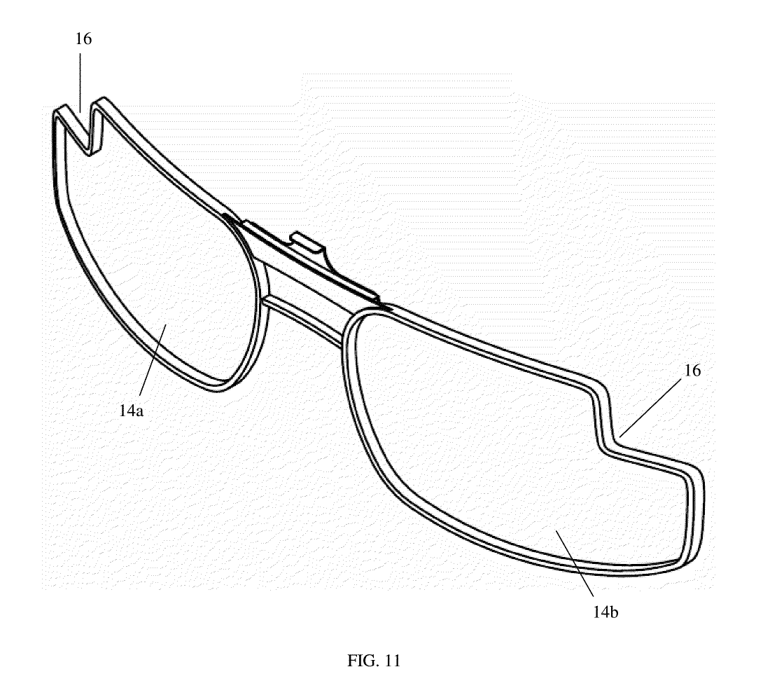

To further affix the lens carrier 10 firmly in place, the clamp 20 can preferably include one or more clips 36 that hook around or overlap at least a portion of the top section of brow bar 12, as shown in FIGS. 4-7. In FIGS. 2 and 8, for example, clamp 20 includes a single clip 36 in the center of the clamp 20. In FIGS. 4 and 10, for example, clamp 20 includes a clip 36 on each end of the clamp. In both embodiments, the clip overlaps a top portion of the brow bar 12 to hold the lens carrier 10 in place, as shown for example in FIGS. 4-7.

Accordingly, when the spacer 18 is placed between the nose pad arms 32 near the brow bar 12, and the clamp 20 is positioned against the back of the spacer 18 and the brow bar 12 with clip 36 overlapping an upper portion of the brow bar 12, the holes 23 in the spacer and the clamp 20 align with the screw sockets 25 in the top bar 28 of the lens carrier 10. Accordingly, the screws 22 can be inserted through the holes 23 in the clamp 20 and then through the holes 23 in the spacer 18, and then can be screwed into the threads located within sockets 25 of the top bar 28. As the screws 22 are screwed in, the top bar, spacer, clamp, clip, and brow bar are tightly pulled together, thereby firmly but reversibly affixing the lens carrier 10 against the brow bar 12.

According to another embodiment, the clamp 20 is attached to the lens carrier 10 by a hinge (not shown) and is snapped into place once the spacer and the lens carrier are properly placed, thereby locking lens carrier 10 in place against brow bar 12. In this embodiment, clamp 20 can include a clip 36 that overlaps a top portion of the brow bar 12 to hold the lens carrier 10 in place.

According to another embodiment as depicted in FIGS. 8-10, lens carrier 10 includes one or more lenses 14a and 14b which can be any lens or material that is or can be utilized in traditional eyeglasses. Similar to previous embodiments, the right lens 14a can be shaped differently from the left lens 14b, with lens 14a (and/or lens 14b) including a notched portion 16 that can accommodate a structure or component, such as a structure or component (not shown) attached to a portion of the brow bar 12.

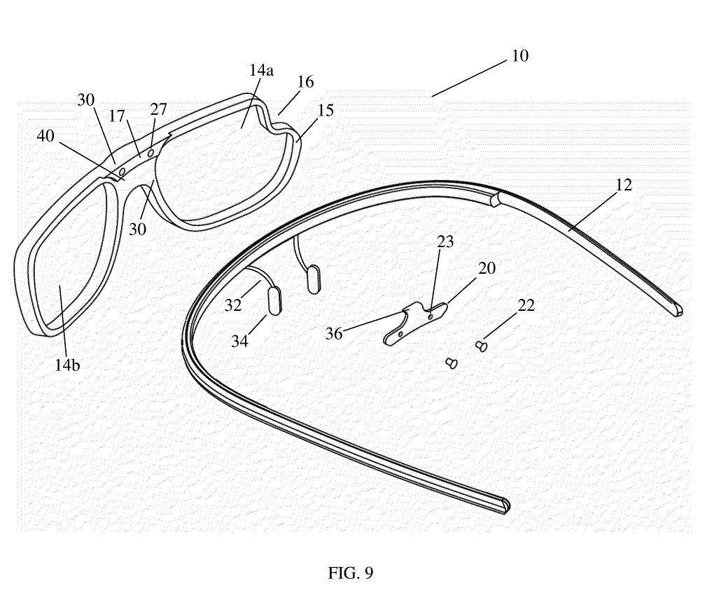

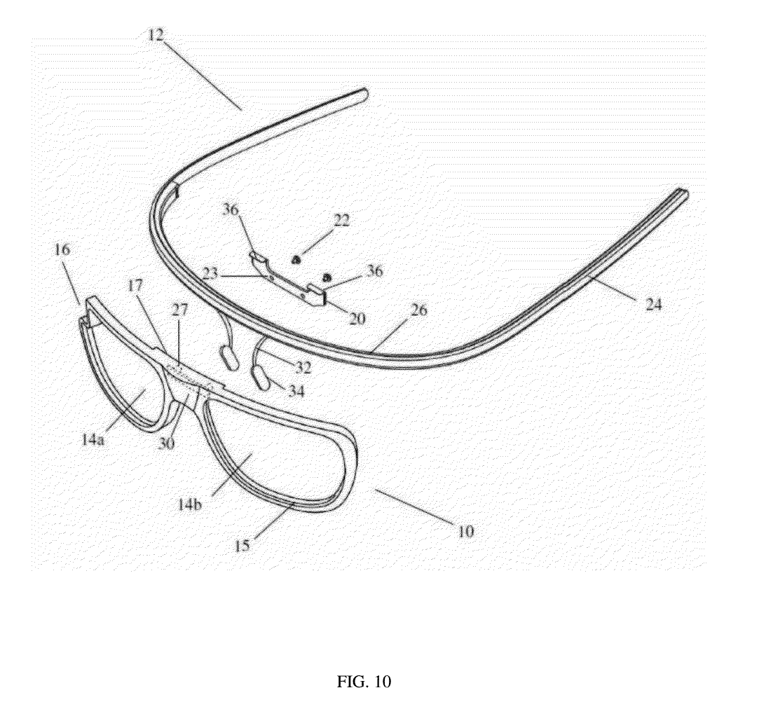

In an embodiment, the pair of lenses 14 is installed in a single unitary structure, such as the lens carrier 10 shown in FIGS. 8-10 forming eye wires or rims 15 around both lenses. The single unitary structure, which can be plastic, metal, glass, or any other material suitable for eyeglasses (including for protection), firmly holds lens 14 in place, and can be designed to allow the lenses to be interchangeable or replaced. In an embodiment, the single unitary structure includes a nose bridge 30 located between the pair of lens members 14. The nose bridge 30 also includes an integral spacer region 17 that extends backward from the lens carrier 10 toward the wearer's face, and thus incorporates a spacer function, as shown in other embodiments. Accordingly, the spacer region 17 of the nose bridge 30 can be shaped to fit within the space between the nose pad arms 32, as shown in FIG. 9. According to one embodiment, the spacer region 17 of the nose bridge 30 is curved or otherwise shaped to accommodate the shape of the nose pad arms 32. If brow bar 12 is slightly curved along the distance of the wearer's brow, for example, the spacer region 17 of the nose bridge 30 may also be slightly curved along its length in order to accommodate this slight curve of the brow bar 12. According to an embodiment, the length of the spacer region 17 can be configured to be equal to or slightly less than the predetermined distance d that separates the nose pad arms 32, which results in the formation of a channel 42 on each side of the spacer region 17, between an end of the spacer region 17, and end of the clamp 20 and a portion of the rim 15, wherein each channel can accommodate a nose pad arm 32, similar to the embodiment shown in FIG. 5. According to an embodiment, once the spacer region 17 is placed between the nose pad arms 32, the back of the spacer may be largely flush with the back of the brow bar 12.

In one embodiment, the spacer region 17 of nose bridge 30 includes a back surface 40 that faces the wearer, as shown in FIG. 9. The back surface 40 can include, for example, one or more posts or screw sockets 27 that extend out from or flush to the back surface 40 toward the wearer, and that can include internal threads or another mechanism to receive screws 22 or another attachment method, as discussed in greater detail below. The posts or screw sockets 27 may be, for example, a portion of a metal, glass, plastic, or other component embedded within the spacer region 17 of the nose bridge 30.

Once the spacer region 17 of the nose bridge 30 is placed within the space between the nose pad arms 32 near the brow bar 12, the clamp 20 can be used to firmly affix lens carrier 10 to brow bar 12. A variety of mechanisms can be utilized to affix the lens carrier to the brow bar using the clamp 20. For example, according to one embodiment, the clamp 20 is placed against the largely flush surface created by a properly-placed extending the spacer region 17 and brow bar 12 and is affixed in place, thereby biasing the lens carrier 10 firmly against the brow bar 12. According to an embodiment, the clamp 20 includes one or more holes 23 that accommodate one or more screws 22. The nose bridge 30 of the lens carrier includes one or more screw sockets 27, as shown in FIGS. 8-10, which has internal threads formed into it to receive and firmly hold the screws 22.

Accordingly to an embodiment, the length of clamp 20 is equal to or slightly greater than the distance of both the nose pad arms 32 and the distance d between the nose pad arms 32. As a result, once the spacer region 17 of the nose bridge 30 is placed within the space between the nose pad arms 32 near the brow bar 12 and an approximately flush surface is created by the spacer region 17 and the nose pad arms 32, the clamp 20 is placed over the spacer region 17 and nose pad arms 32 and then firmly attached, thereby locking the nose pad arms firmly in place. For example, when the clamp 20 is positioned against the back of the top bar and the brow bar with the clip 36 overlapping an upper portion of the brow bar, the holes 23 in the clamp 20 align with the sockets 27 in the nose bridge 30. Accordingly, the screws 22 or other attachment mechanism can be inserted through the holes 23 in the clamp 20 and then can be screwed into the threads located within sockets 27 of the nose bridge 30. As the screws 22 are screwed in, the nose bridge, clamp and brow bar are more tightly pulled together, thereby firmly but reversibly affixing the brow bar against the lens carrier.

According to another embodiment, the length of spacer region 17 is approximately the same as or slightly greater than the distance d, and the ends of the spacer region 17 are shaped to receive nose pad arms 32. Thus, a force is required to push the spacer region 17 into the space between the nose pad arms 32 for a push-fit and align the channels created at the ends of the spacer region. Aligning the nose pad arms 32 with the channels in the ends of the spacer region, due to the shape of the channels and the length of the spacer region 17, force is required to remove the nose pad arms from the channels. The ends of spacer region 17 are curved and notched or otherwise shaped to accommodate the shape of the nose pad arms 32 and more firmly be held in place. Accordingly, the spacer region 17 will firmly but reversibly fit within the space between the nose pad arms 32 near the brow bar 12. Once the spacer region 17 is placed within this space, and attached to the brow bar 12, the back of the spacer region 17 is largely flush with the back of the brow bar 12. In accordance with this embodiment, the clamp 20 is an optional component of the attachment member 21 since the nose pad arms 32 are secured between the ends of the spacer region 17 and a corresponding portion of the rims 15 by a channel formed by the spacer region ends and portion of the rims.

Although the present invention has been described in connection with a preferred embodiment, it should be understood that modifications, alterations, and additions can be made to the invention without departing from the scope of the invention as defined by the claims.

1. A lens carrier adapted to be mounted to a brow bar comprising a horizontal bar and a pair of nose pad arms extending downwardly from the horizontal bar, the lens carrier comprising:
a pair of lens rims, each rim adapted to support a lens; and
a nose bridge coupled between the pair of lens rims and comprising a back surface, wherein the back surface comprises a spacer region configured to fit between the pair of nose pad arms and reversibly mount the lens carrier to the brow bar.

2. The lens carrier of claim 1, wherein the lens carrier is reversibly mounted to the brow bar by a pair of channels formed on either side of the nose bridge, each channel of the pair of channels being formed by an end of the spacer region and a portion of the rim when assembled, wherein the end of the spacer region has a shape complementary to the shape of the corresponding nose pad arm.

3. The lens carrier of claim 1, wherein the nose pad arms are separated by a distance d, and the length of the spacer region is equal to or slightly greater than the distance d, such that the lens carrier reversibly mounts to the brow bar by a snap-fit.

4. The lens carrier of claim 1, further comprising a clamp configured to engage the brow bar, the pair of nose pad arms and the spacer region to reversibly mount the lens carrier to the brow bar.

5. The lens carrier of claim 1, wherein the nose bridge comprises a top bar coupled between the pair of lens rims and the top bar comprises the back surface.

6. The lens carrier of claim 5, further comprising a clamp configured to engage the brow bar, the pair of nose pad arms and the spacer region to reversibly mount the lens carrier to the brow bar.

7. The lens carrier of claim 6, wherein the spacer region further comprises a spacer adapted to attach to the back surface of the nose bridge and the clamp.

8. The lens carrier of claim 7, wherein the nose pad arms are separated by a distance d, and the length of the spacer is equal to or slightly less than the distance d, so that the lens carrier reversibly mounts to the brow bar by a clamp-fit.

9. The lens carrier of claim 8, wherein the length of the clamp is slightly greater than the distance d plus the width of the pair of nose pad arms.

10. The lens carrier of claim 9, wherein the lens carrier is reversibly mounted to the brow bar by a pair of channels, each channel formed on either side of the nose bridge by an end of the spacer, a corresponding portion of the rim, and an end of the clamp which overhangs the end of the spacer when assembled.

11. The lens carrier of claim 6, wherein the clamp further comprises at least one clip extending upwardly from the clamp, the at least one clip configured to overlap and frictionally engage a top portion of the brow bar.

12. The lens carrier of claim 1, wherein the nose bridge comprises a top bar coupled between the lens rims and comprising a back surface;
wherein the spacer region comprises a spacer configured to fit between the nose pad arms, wherein the spacer comprises a first hole and a second hole;
further comprising a clamp comprising a first hole and a second hole and a clip extending upwardly from the clamp and configured to overlap and frictionally engage a top portion of the brow bar;
further comprising a first fastener configured to extend through the first hole of the spacer and the first hole of the clamp when the spacer and the clamp are aligned; and
a second fastener configured to extend through the second hole of the spacer and the second hole of the clamp when the spacer and the clamp are aligned;
wherein tightening the first and second fasteners locks the spacer between the clamp, the top bar, and the nose pad arms, and biases the clip against the brow bar to reversibly mount the lens carrier to the brow bar by a pair of channels, each channel formed on either side of the nose bridge of the lens carrier by an end of the spacer, a corresponding portion of the lens rim, and an end of the clamp which overhangs the end of the spacer member.

13. A lens carrier adapted to be mounted to a brow bar comprising a horizontal bar and a pair of nose pad arms extending downwardly from the horizontal bar, the lens carrier comprising:
a pair of lens rims, each rim adapted to support a lens;
a nose bridge coupled between the pair of lens rims and comprising a back surface;
a spacer configured to fit between the pair of nose pad arms; and
a clamp configured to attach the spacer to the back surface of the nose bridge to reversibly mount the lens carrier to the brow bar.

14. A lens carrier of claim 13, wherein the nose bridge comprises a top bar coupled between the pair of lens rims and the top bar comprises the back surface.

15. The lens carrier of claim 13, wherein the nose bridge comprises a top bar coupled between the lens rims;
wherein the spacer comprises a first hole and a second hole and is configured to fit between the nose pad arms;
wherein the clamp comprises a first hole and a second hole;
further comprising a first fastener configured to extend through the first hole of the spacer and the first hole of the clamp when the spacer and the clamp are aligned; and
a second fastener configured to extend through the second hole of the spacer and the second hole of the clamp when the spacer and the clamp are aligned;
wherein tightening the first and second fasteners attaches the spacer between the clamp, the top bar, and the nose pad arms to reversibly clamp-on the lens carrier to the brow bar.
